(19) United States
(12) Patent Application Publication
(10) Pub. No.: US 2009/0153484 A1
(43) Pub. Date: Jun. 18, 2009

(54) MOUSE AND METHOD FOR CURSOR CONTROL

(75) Inventor: ZHONGQING LI, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignees: BEIJING LENOVO SOFTWARE LTD., Beijing (CN); LENOVO (BEIJING) LIMITED, Beijing (CN)

(21) Appl. No.: 12/332,777

(22) Filed: Dec. 11, 2008

(30) Foreign Application Priority Data
Dec. 12, 2007 (CN) 2007-10179372.5

(51) Int. Cl. G09G 5/08

(52) U.S. Cl. 345/164

(57) ABSTRACT

A mouse and a method for controlling such a mouse are disclosed. The mouse comprises a plurality of balls which are classified into at least two groups, each of which has a function; a plurality of sensors connected to the plurality of balls for sensing and measuring the plurality of balls, and obtaining the scrolling value of each of the plurality of balls; a processing unit connected to the plurality of sensors for processing the corresponding scrolling values of the balls in each group respectively and generating at least two sorts of operating information, each of which corresponds to a function. In addition, it is possible to define several functional combinations so as to achieve functions such as scrolling up and down, scrolling left and right, go forward and backward, and even time editing or revising.

### BACKGROUND OF THE INVENTION

1. Field of Invention

The present invention relates to peripheral devices of the computer, and in particular to a mouse and a method for cursor control.

2. Description of Prior Art

Known computer input device for example is a scroll ball mouse, a touchpad, a trackpoint, or etc. In use, the user scrolls the scroll ball arranged on the mouse. When the scroll ball moves, a position sensor detects the scrolling angles of the scroll ball along X and Y directions, and converts them into relative moving distances. Then a subsequent processing unit converts the relative moving distances into a moving distance along a certain direction, which is mapped to a motion path of cursor on the screen. However, since the size of the scroll ball mouse is too big, it can not be applied to the notebook computer directly and can only be connected to the host by wires or wirelessly. In addition, when using the scroll ball mouse, the user has to frequently move his hands between the keyboard and the mouse in order to carry out the required input operations.

Nor can photoelectric position detection mouse be applied to the notebook, since there is a need for detecting the image on the motion path, which cannot be realized mainly because the area of the finger is too small as compared with the moving distance of the cursor.

Furthermore, typically the touchpad provided in the notebook computer is a smooth plane. When the finger moves on the surface of this plane, the sensor maps the moving distance and moving direction of the finger to the movement of the cursor on the screen. However, since the area touched by the finger, the moving velocity of the finger and the applied force are changing over time, the moving distance of the finger is out of proportion to the actual moving distance of the cursor on the screen. This can lead to a phenomenon that while the moving distance of the finger is long, the moving distance of the cursor is short, as if the finger were skidding on the touch pad, and thereby the operational flexibility will drastically decrease. Furthermore, the touch pad doesn't have the ability to accelerate the movement of the cursor. If the ratio of the moving distance of the cursor to the moving distance of the finger is adjusted, the positioning accuracy will be influenced.

In addition, one problem with the trackpoint provided in the existing notebook computer is that in the course of using the trackpoint, the finger should be placed on the small red hat of the trackpoint all the time, and exerts a force on the red hat along the desired direction. In this case, the finger is prone to sweat and get tired. Therefore, it is very hard to operate the trackpoint for a beginner.

### SUMMARY OF THE INVENTION

An object of the present invention is to provide a mouse arranged on the keyboard of the desktop computer or the operation panel of the notebook computer and a method for the same mouse. The present solution can not only be applied to the keyboard of the desktop computer or the operation panel of the notebook computer, but can also be used as a separate mouse, or be applied to other occasions where cursor positioning is needed.

According to an aspect of the present invention, there is provided a mouse comprising a plurality of balls divided into at least two groups, each of the at least two groups is corresponding to a function; a plurality of sensors connected to the plurality of balls, the plurality of sensors for sensing the plurality of balls, and obtaining the scrolling value of each of the plurality of balls; a processing unit, connected to the plurality of sensors, for processing the scrolling value of each ball of the at least two groups, and generating at least two sorts of operating information, each of the at least two sorts of operating information corresponds to a function.

Preferably, the processing unit includes an adder for adding the scrolling values of each ball of the at least two group.

Preferably, the processing unit includes a multiplier for multiplying the scrolling values of each ball of the at least two group.

Preferably, the mouse further comprises two micro switches mounted under two of the plurality of balls.

Preferably, the plurality of balls are arranged in one plane.

Preferably, the plurality of balls are arranged in different planes.

According to another aspect of the present invention, there is provided a notebook computer comprising a plurality of balls which are classified into at least two groups of balls, each of groups has a function; a plurality of sensors connected to the plurality of balls for sensing the plurality of balls, and obtaining the scrolling value of each of the plurality of balls; a processing unit connected to the plurality of sensors for processing the corresponding scrolling values of the balls in each group respectively and generating at least two sorts of operating information, each of which corresponds to a function; a central processing unit, connected to the processing unit via a computer bus; and a display, connected to the central processing unit, wherein the central processing unit processes the operating information, and displays the processing result on the screen of the display.

Preferably, the notebook computer further comprises micro switches mounted under the corresponding ones of the at least two scroll balls, functioning as the left and right mouse buttons.

According to another aspect of the present invention, there is provided a method for the mouse comprising at least two groups of balls, each of which has a function. The method comprises the steps of: sensing the plurality of balls, and obtaining the scrolling value of each of the plurality of balls; and processing the corresponding scrolling values of the balls in each group respectively and generating at least two sorts of operating information, each of which corresponds to a function.

Preferably, the step of processing comprises generating at least two first operating values respectively by adding the corresponding scrolling values of the balls in each group together, and using the first operating values as the operating information.

Preferably, the step of processing comprises generating at least two first operating values respectively by multiplying the corresponding scrolling values of the balls in each group together, and using the first operating values as the operating information.

Preferably, the step of processing comprises generating at least two second operating values respectively by multiplying the first operating values by coefficients respectively, and using the second operating values as the operating information.

As such, the mouse according to the embodiment of the present invention gains the ability to accelerate the movement of the cursor. When the user presses the mouse heavily, the contact region is larger, and the displacements of several scroll balls which are scrolled will be summed up. In addition, it is possible to define several functional combinations so as to achieve functions such as scrolling up and down, scrolling left and right, go forward and backward, and even time editing or revising (for example, redo and undo).

### BRIEF DESCRIPTION OF THE DRAWINGS

The preferred embodiments of the present invention are described below with reference to the drawings, in which:

FIG. 1 shows a block diagram of a mouse according to an embodiment of the present invention;

FIG. 2 shows an example of the arrangement and operation of the scroll balls of the mouse according to an embodiment of the present invention;

FIG. 3 shows an example of the arrangement and operation of the scroll balls of the mouse according to an embodiment of the present invention;

FIG. 4 shows an example of the operation of the mouse according to an embodiment of the present invention;

FIG. 5 shows an example of the operation of the mouse according to an embodiment of the present invention;

FIG. 6 shows the applications of the mouse according to an embodiment of the present invention on the notebook computer;

FIG. 7 is diagram illustrating the layout of the mouse according to an embodiment of the present invention on the keyboard of the notebook computer;

FIG. 8 shows the application of the mouse according to an embodiment of the present invention as a separate device.

### DETAILED DESCRIPTION OF THE PREFERRED EMBODIMENTS

Now, the present invention will be described in detail in conjunction with embodiments with reference to the accompanying drawings.

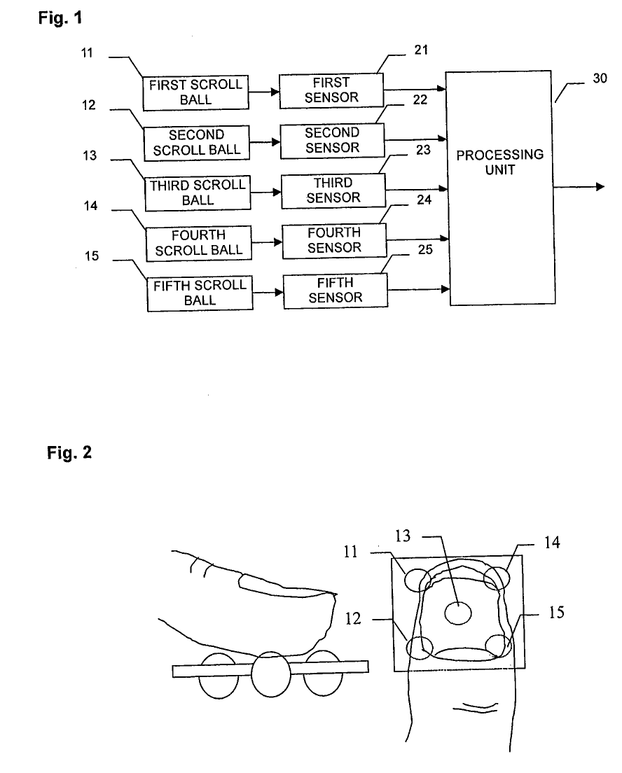

FIG. 1 shows a block diagram of a mouse according to an embodiment of the present invention. As shown in FIG. 1, the mouse according to an embodiment of the present invention is provided with a first scroll ball 11, a second scroll ball 12, a third scroll ball 13, a fourth scroll ball 14, a fifth scroll ball 15. For example, the above five scroll balls can be divided into four groups. In particular, the third scroll ball can be one group, the second and fifth scroll balls can be assigned to first group, the fourth and the fifth scroll balls can be assigned to second group, and the first, second, third, fourth and the fifth scroll balls can be assigned to third group. Each of the groups corresponds to a kind of function, such as controlling the movement of the cursor, accelerating the movement of the cursor, scrolling up and down, and scrolling left and right. The mouse may be further provided with a first sensor 21 for detecting the scrolling of the first scroll ball, a second sensor 22 for detecting the scrolling of the second scroll ball, a third sensor 23 for detecting the scrolling of the third scroll ball, a fourth sensor 24 for detecting the scrolling of the fourth scroll ball, a fifth sensor 25 for detecting the scrolling of the fifth scroll ball, and a processing unit 30 for processing the values detected by these five sensors.

According to an embodiment of the present invention, the first to fifth sensors 21-25 sense and measure the scrolling values such as scrolling angle and scrolling direction of the corresponding scroll ball driven by external force. As such, since the diameter of the scroll ball is known, the processing unit 30 can calculate the scrolling distance scrolled by each of the scroll balls. Furthermore, the processing unit 30 processes the corresponding scrolling values of the scroll balls in each group, and generates at least two sorts of operating information, each of which corresponds to the function such as scrolling up and down, and scrolling left and right.

For example, the processing unit 30 may sum up the corresponding scrolling values of the scroll balls in each group respectively, generates at least two first operating values respectively, and uses them as operating information. In particular, the processing unit 30 may be an adder, for example. When the user scrolls the five scroll balls to the right, the processing unit calculates the scrolling distance of each scrolling ball, adds these distances together, and uses the result as the moving distance of the cursor on the screen.

According to another embodiment of the present invention, the processing unit 30 multiplies the total moving distance of the five scroll balls by a preset coefficient (for example, 0.8), and uses the weighted distance as the moving distance of the cursor.

According to yet another embodiment of the present invention, the processing unit 30 multiples the corresponding scrolling values of the scroll balls in each group together respectively, generates at least two first operating values respectively, and uses these first operating values as the operating information. In particular, the processing unit 30 may be a multiplier which multiplies the moving distances of the five scroll balls together and uses the result as the moving distance of the cursor on the screen.

According to an embodiment of the present invention, the mouse may be further provided with a calculating unit, connected to the adder, for multiplying the first operating values by coefficients respectively, generating at least two second operating values respectively, and using these second operating values as the operating information.

FIG. 2 is a diagram illustrating the arrangement of each of the scroll balls of the mouse according to an embodiment of the present invention. As shown in FIG. 2, the first, second, fourth, fifth scroll balls of the five scroll balls are arranged at the four corners of a rectangular area, and the third scroll ball is arranged at the center of the rectangular area. As such, if the user wants to control the cursor more accurately, he can scroll only the third scroll ball 13 located at the center of the area.

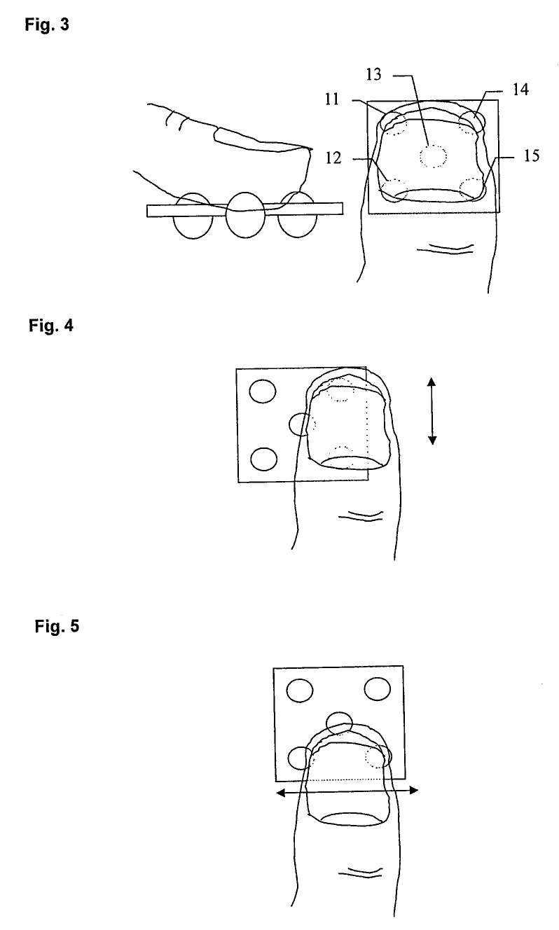

As shown in FIG. 3, if the user wants to accelerate the movement of the cursor, he can scroll the five scroll balls lightly.

According to an embodiment of the present invention, for ease of operation, the scroll ball 13 located at the center of the five balls can be arranged at a height different from those of the other scroll balls. For example, if the scroll ball 13 is slightly lower than the other scroll balls, then it will be very convenient for the user to operate with a single finger. If the scroll ball 13 is slightly higher than the other scroll balls, then it will be very convenient for the user to operate with his whole palm.

FIGS. 4 and 5 shows the operations of scrolling the mouse according to an embodiment of the present invention up and down, and scrolling it left and right. As shown in FIG. 4, the column of the scroll balls on the right side of the five scroll balls 11-15, i.e. the fourth scroll ball 14 and the fifth scroll ball 15 is defined as a group, and used to scroll up and down; the lower row, i.e. the second scroll ball 12 and the fifth scroll ball 15 is defined as another group, and used to scroll left and right.

As such, when the user operates the fourth scroll ball 14 and fifth scroll ball 15, the page displayed on the screen will scroll up and down. When the user operates the second scroll ball 12 and fifth scroll ball 15, the page displayed on the screen will scroll left and right.

Moreover, according to an embodiment of the present invention, two micro switches are mounted under the first scroll ball 11 and the fourth scroll ball 14 on the upper side, and are used as the left and right buttons of the mouse.

According to another embodiment of the present invention, two scroll balls on the left side may form a group which is used to support functions “undo” and “redo”, and two scroll balls on the upper side may form a group which is used to switch to the previous or subsequent web page.

As such, according to an embodiment of the present invention, the processing unit 30 may use the following control logic to control the cursor on the screen:

IF C not (A, B, D, E), move the cursor

IF A, B, C, D, E, the moving distance of the cursor=(A distance+B distance+C distance+D distance+E distance)×coefficient

IF B, E not A, D, scroll the page up and down

IF A, D not B, E, scroll the page left and right

IF A, D not B, E, undo and redo

IF A, D not B, E, move back to the previous web page and move forward to the subsequent web page.

Wherein A, B, C, D, E represents the first to fifth scroll ball 11-15 respectively.

Although the above description is given with respect to the situation of five scroll balls, it is also possible to use two or three scroll balls to control the cursor. One of these scroll balls can be defined as the main scroll ball, in order to make it easy for the user to operate accurately. One of these scroll balls can be defined as the auxiliary scroll ball. When the user scrolls the main scroll ball and the auxiliary scroll ball at the same time, the sum of moving distances of the two scroll balls can be used to control the cursor on the screen.

Furthermore, the five scroll balls can be arranged in a cross comprised of a row and a column, with three scroll balls in the row and three scroll balls in the column. The scroll ball at the center is the cross point of the row and the column.

The user can also operate the scroll ball at the right side of the row to scroll up and down, operate the scroll ball at the lower side of the column to scroll left and right, operate the scroll ball at the left side of the row to undo and redo, and operate the scroll ball at the upper side of the column to switch to the previous web page or the subsequent web page.

The mouse according to an embodiment of the present invention employs a plurality of small scroll balls which form an array of scroll balls. This arrangement makes the user's operation more convenient. In addition, since the above mouse can be arranged on the keyboard of the desktop computer or on the operation panel of the notebook computer, there is no need for seeking the mouse, so that it is more convenient to switch between keyboard keys and the mouse.

In addition, the scroll balls can be arranged on a button. As a result, when the user scrolls it lightly, only one of the scroll balls is touched, so the displacement is very small, but the positioning can be very accurate. On the other hand, when the user scrolls it heavily, the contact region is larger and more than one scroll ball is touched, so adding the displacement of each ball together can make the distance longer. In this way, it is easier to control the operation.

Furthermore, the mouse can be arranged in the center of the keyboard to replace the trackpoint, it can also be arranged at the original position of the touchpad to replace the touchpad, and it can be arranged on the traditional mouse to replace the detect unit of the mouse as well.

Scroll balls at different positions may have different functions. The functions of the scroll ball at the center and the scroll balls at the corners can be prescribed arbitrarily. For example, the two scroll balls on the right side can be used for scrolling up and down, the two scroll balls on the lower side can be used for scrolling left and right, and the two scroll balls on the upper side can be used for switch to the previous web page or the subsequent web page.

According to an embodiment of the present invention, the mouse described above can be mounted on the keyboard or be formed as a part separated from the host.

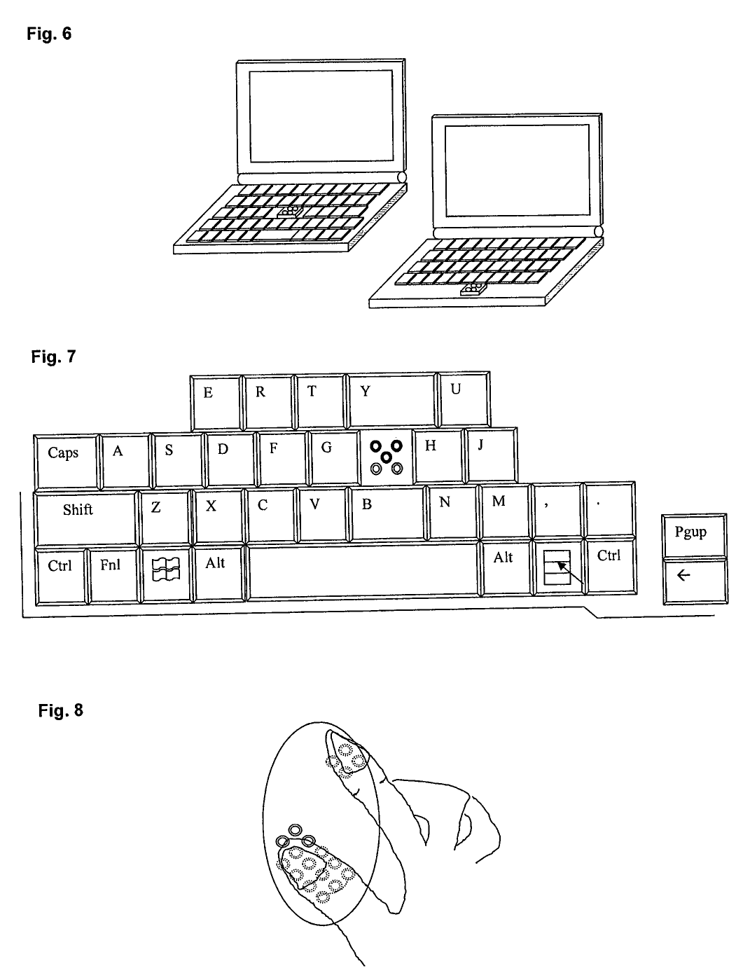

FIG. 6 shows the applications of the mouse on the notebook computer. It can be arranged in the center of the keyboard to replace the trackpoint, and it can also be arranged below the keyboard to replace the touchpad.

FIG. 7 shows the layout of a notebook computer keyboard with a plurality of scroll balls. These scroll balls can also be applied to the keyboard of a desktop computer, or other cursor positioning devices such as the operation panel of type-B ultrasonic apparatus.

FIG. 8 shows the application of the mouse as a separate device. In this case, the user can use his thumb to control the position of the cursor, use his forefinger to press the button or perform other operations, and use his remaining fingers to hold the mouse.

The mouse according to the embodiment described above can be implemented on a notebook computer. In this case, the notebook computer is provided with at least two scroll balls; at least two sensors, for sensing which of the at least two scroll balls is scrolled and measuring its scrolling value.

In addition, the notebook computer is further provided with a processing unit 30 connected to the plurality of sensor for processing the corresponding scrolling values of the scroll balls in each group respectively and generating at least two sorts of operating information, each of which corresponds to a function; a central processing unit connected to the processing unit via a computer bus; and a display connected to the central processing unit, wherein the central processing unit processes the operating information, and displays the processing result on the screen of the display. For example, the user scrolls the five scroll balls shown in FIG. 7 with his fingers, then the scrolling values of the five scroll balls will be sensed and measured by the sensor arranged under each of scroll balls. As such, the processing unit connected to the sensors may calculate a value, which is used to control the movement of the cursor, in accordance with the scrolling values of the five scroll balls, and send it to the CPU (central processing unit) via the bus of the notebook computer. Finally the CPU controls the movement of the cursor on the screen according to the value which is used to control cursor positioning. Preferably, micro switches are arranged under the two scroll balls on the upper side of the five scroll balls shown in FIG. 7. The function of the left button of traditional mouse can be realized by pressing the micro switch of the scroll ball on the left side. The function of the right button of traditional mouse can be realized in the same manner, and will not be described repeatedly.

Although several embodiments of the present invention have been shown and described above, any modifications and variations which can be contemplated by those skilled in the art readily and falls within the technical scope disclosed by the present invention should be covered within the scope of the present invention. Therefore, the scope of protection of the present invention should be based on the scope of protection of the claims.

1. A mouse comprising:
a plurality of balls divided into at least two groups, each of the at least two groups is corresponding to a function;
a plurality of sensors connected to said plurality of balls, the plurality of sensors for sensing each of said plurality of balls, and obtaining the scrolling value of each of said plurality of balls;
a processing unit connected to said plurality of sensors for processing the scrolling value of each ball of the at least two groups, and generating at least two sorts of operating information, each of said at least two sorts of operating information corresponds to a function.

2. The mouse according claim 1, wherein said processing unit includes an adder for adding the scrolling values of each ball of the at least two group.

3. The mouse according claim 1, wherein said processing unit includes a multiplier for multiplying the scrolling values of each ball of the at least two group.

4. The mouse according claim 1, further comprising:
two micro switches mounted under two of said plurality of balls.

5. The mouse according claim 1, wherein said plurality of balls are arranged in one plane.

6. The mouse according claim 1, wherein said plurality of balls are arranged in different planes.

7. A notebook computer comprising:
a plurality of balls;
a plurality of sensors connected to said plurality of balls for sensing said plurality of balls, and obtaining the scrolling value of each of said plurality of balls;
a processing unit connected to said plurality of sensors for processing the corresponding scrolling values of the balls in each group respectively and generating at least two sorts of operating information, each of which corresponds to a function;
a central processing unit connected to said processing unit via a computer bus; and
a display connected to said central processing unit, wherein said central processing unit processes said operating information, and displays the processing result on the screen of the display.

8. The notebook computer according claim 7, further comprising:
two micro switches mounted under two of said plurality of balls, functioning as the left and right mouse buttons.

9. A method for a mouse comprising at least two groups of balls, each of which corresponds a function, the method comprising:
sensing said plurality of balls, and obtaining the scrolling value of each of said plurality of balls; and
processing the corresponding scrolling values of the balls in each group respectively and generating at least two sorts of operating information, each of which corresponds to a function.

10. The method according claim 9, wherein said step of processing comprises:
generating at least two first operating values respectively by adding the corresponding scrolling values of the balls in each group together, and using said first operating values as said operating information.

11. The method according claim 9, wherein said step of processing comprises:
generating at least two first operating values respectively by multiplying the corresponding scrolling values of the balls in each group together, and using said first operating values as said operating information.

12. The method according claim 9, wherein said step of processing comprises:
generating at least two second operating values respectively by multiplying the first operating values by coefficients respectively and using said second operating values as the operating information.

13. The method according claim 10, wherein said step of processing comprises:
generating at least two second operating values respectively by multiplying the first operating values by coefficients respectively and using said second operating values as the operating information.
